(19) United States
(12) Patent Application Publication
(10) Pub. No.: US 2026/0300839 A1
(43) Pub. Date: Oct. 1, 2026

(54) PARAMETER ITERATION METHOD FOR ARTIFICIAL INTELLIGENCE TRAINING

(71) Applicant: Han-Wei Zhang, New Taipei City (TW)

(72) Inventor: Han-Wei Zhang, New Taipei City (TW)

(21) Appl. No.: 19/704,930

(22) Filed: Jun. 11, 2026

Related U.S. Application Data
(63) Continuation-in-part of application No. 17/325,680, filed on May 20, 2021.

(51) Int. Cl. G06N 20/00

(52) U.S. Cl. CPC G06N 20/00

(57) ABSTRACT

A parameter iteration method for artificial intelligence training includes: providing a training set and setting a numerical range; selecting at least three initial set values from the numerical range, calculating an accuracy rate of the initial set values, and setting a first parameter range by using the initial set value having a highest accuracy rate; selecting at least three first iteration values from the first parameter range, calculating an accuracy rate of the first iteration values, comparing the accuracy rates of the first iteration values with each other, and setting a second parameter range by using the first iteration value having a highest accuracy rate as a second core value; and determining whether the accuracy rate of the second core value is higher than 0.9, and setting the second core value as a training parameter standard value if higher than 0.9.

### CROSS-REFERENCE TO RELATED APPLICATION

This application is a continuation-in-part (cip) of application Ser. No. 17/325,680, filed on 2021 May 20. The prior applications are herewith incorporated by reference in its entirety.

### BACKGROUND

### Technical Field

This application relates to the field of artificial intelligence, an in particular, to a parameter iteration method for artificial intelligence training.

### Related Art

With advancement of science and technology, artificial intelligence is applied to increasing aspects. For example, artificial intelligence is gradually applied to defect detection, face recognition, medical judgement, and the like. Before general artificial intelligence actually enters an application field, data usually needs to be trained. The data may be trained by using algorithms such as a neural network, a convolutional neural network (CNN), or the like.

Currently, deep learning of the CNN is a most common learning and training method for image discrimination. Since current training parameters are usually random number settings, and an amount of inputted data is huge, a large amount of calculation data is generated during calculation process. As a result, burdens of memories and computing resources are relatively large, resulting in a long training time and poor efficiency.

### SUMMARY

A parameter iteration method for artificial intelligence training is provided herein. The parameter iteration method for artificial intelligence training includes a setting step, an initialization step, a parameter optimization step, and a determination step. The setting step includes providing a training set and setting a numerical range for at least two training parameters. The initialization step includes randomly selecting at least three initial set values from the numerical range for the training parameters, calculating an accuracy rate of each of the initial set values according to the training set, and setting a first parameter range by using the initial set value having a highest accuracy rate as a first core value and using a parameter coordinate value of the first core value as a physical center. The parameter optimization step includes selecting at least three first iteration values from the first parameter range, calculating an accuracy rate of each of the first iteration values according to the training set, comparing the accuracy rates of the at least three first iteration values, and setting a second parameter range by using the first iteration value having a highest accuracy rate as a second core value and using a parameter coordinate value of the second core value as a physical center. The determination step includes determining whether the accuracy rate of the second core value is higher than 0.9, if the accuracy rate of the second core value is higher than 0.9, ending the parameter optimization step and setting the second core value as a training parameter standard value, or if the accuracy rate of the second core value is not higher than 0.9, replacing the first core value and the first parameter range with the second core value and the second parameter range respectively, repeating the parameter optimization step until an accuracy rate of a test core value is higher than 0.9, and setting parameter coordinates of the test core value as the training parameter standard value.

In some embodiments, the at least two training parameters include a batch size and a learning rate, the batch size ranges from 0.5 to 1.5, the learning rate ranges from 0.5 to 1.5, and the first parameter range is a circle on a coordinate system having the batch size and the learning rate as a horizontal axis and a vertical axis respectively, which has the first core value as a center of the circle. More specifically, in some embodiments, the batch size ranges from 0.7 to 1.3, and the learning rate ranges from 0.7 to 1.3.

More specifically, in some embodiments, in the initialization step, the selection of the batch sizes and the learning rates of the initial set values and the calculation of the accuracy rate are performed by two graphics processors respectively.

In some embodiments, at least two parameters further include a momentum ranging from 0 to 1, and herein, the first parameter range is a sphere on a coordinate system having the batch size, the learning rate, and the momentum as an x-axis, a y-axis, and a z-axis respectively, which has the first core value as a center of sphere. More specifically, the momentum ranges from 0.3 to 0.8.

In some embodiments, the at least two parameters further include a normalization ranging from 0.00001 to 0.001, and the first parameter range is a physical quantity range on a coordinate system having the batch size, the learning rate, the momentum, and the normalization as an x-axis, a y-axis, a z-axis, and a w-axis respectively, which has the first core value as a physical center. More specifically, in some embodiments, the normalization ranges from 0.0001 to 0.0005.

In some embodiments, in the initialization step, any two of the batch size, the learning rate, the momentum, and the normalization are selected by a first graphics processor, the other two of the batch size, the learning rate, the momentum, and the normalization are selected by a second graphics processor, and the accuracy rate is calculated by a third graphics processor.

In some embodiments, the parameter iteration method for artificial intelligence training further includes a verification step. The verification step includes providing a test set, calculating the accuracy rate by using the second core value or the test core value in the determination step that has the accuracy rate higher than 0.9, and performing the initialization step again if the accuracy rate calculated according to the test set is lower than 0.9.

Some embodiments of the present invention provide a parameter iteration method for artificial intelligence training, executed by a processing module and comprising: (a) initializing a plurality of hyperparameter vectors corresponding to a plurality of hyperparameters; initializing a target accuracy rate and a counting variable; obtaining an accuracy rate of each of the hyperparameter vectors; and setting the one with a highest accuracy rate as a best solution vector, and setting the one with a lowest accuracy rate as a worst solution vector; (b) in response to the accuracy rate of the best solution vector being greater than the target accuracy rate, updating the target accuracy rate to the accuracy rate of the best solution vector; in response to a termination condition being satisfied, outputting the best solution vector and exiting; calculating a center point vector between the best solution vector and a chosen solution vector; taking the center point vector as a starting point, selecting a plurality of reflection point vectors based on a vector pointing from the worst solution vector toward the center point vector and a plurality of first random numbers located in a first interval including 1; and obtaining an accuracy rate for each of the reflection point vectors; (c) in response to an accuracy rate of a best reflection point vector among the reflection point vectors being higher than the accuracy rate of the best solution vector, performing: taking the center point vector as a starting point, selecting a plurality of expansion point vectors based on a vector pointing from the center point vector toward the best solution vector and a plurality of second random numbers, wherein the second random numbers are all greater than 1; obtaining an accuracy rate for each of the expansion point vectors; updating the worst solution vector to the one with the higher accuracy rate between the best expansion point vector and the best reflection point vector; (d) in response to the accuracy rate of the best reflection point vector among the reflection point vectors being not higher than the accuracy rate of the best solution vector, performing: taking the center point vector as a starting point, selecting a plurality of contraction point vectors based on a vector pointing from the center point vector toward the worst solution vector and a plurality of third random numbers, wherein the third random numbers are all less than 1; obtaining an accuracy rate for each of the contraction point vectors; in response to an accuracy rate of a best contraction point vector among the contraction point vectors being higher than the accuracy rate of the worst solution vector, updating the worst solution vector to the best contraction point vector; and (e) performing an averaging operation using the best solution vector and each of the hyperparameter vectors to update the hyperparameter vectors; obtaining the accuracy rate of each of the hyperparameter vectors; and updating the counting variable and returning to step (b).

In conclusion, through the parameter iteration method for artificial intelligence training, parameter values can be more quickly selected, and an overall artificial intelligence training process can be accelerated, thus achieving faster gradient descent of the artificial training with fewer files at a larger speed, which can shorten a training time and significantly improve training efficiency.

### BRIEF DESCRIPTION OF THE DRAWINGS

FIG. 1 is a flowchart of a parameter iteration method for artificial intelligence training.

FIG. 2 is a schematic diagram of an initialization step.

FIG. 3 and FIG. 4 are schematic diagrams of a parameter optimization step.

FIGS. 5A-5C illustrates a flowchart of a parameter iteration method for artificial intelligence training according to some embodiments of the present invention.

FIG. 6 illustrates a schematic diagram illustrating selection of reflection point vectors according to some embodiments of the present invention.

FIG. 7 illustrates a schematic diagram illustrating selection of expansion point vectors according to some embodiments of the present invention.

FIG. 8 illustrates a schematic diagram illustrating selection of contraction point vectors according to some embodiments of the present invention.

FIG. 9 is a block diagram illustrating an electronic equipment system according to some embodiments of the present invention.

### DETAILED DESCRIPTION

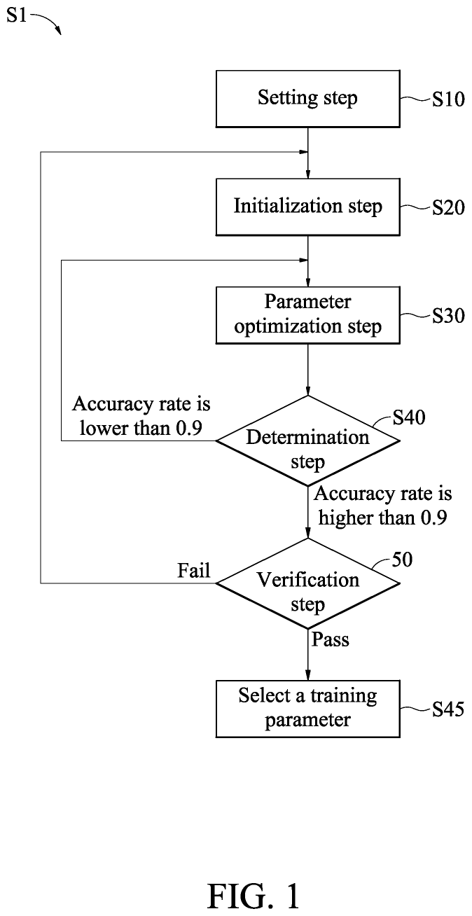

FIG. 1 is a flowchart of a parameter iteration method for artificial intelligence training. As shown in FIG. 1, a parameter iteration method S1 for artificial intelligence training includes a setting step S10, an initialization step S20, a parameter optimization step S30, and a determination step S40.

The setting step S10 includes providing a training set and setting a numerical range for at least two training parameters. The artificial intelligence training is performed through a convolutional neural network (CNN) by using a model of a stochastic gradient descent method as a training set herein. The model may be equation (I) shown below. However, this is merely an example but not a limitation. The training set herein further includes algorithms such as loss calculation.

$${w}_{t + 1} = {w}_{t} - η \frac{1}{n} {\sum }_{x ∈ ℬ} ∇ l ( x , {w}_{t} ) . , \qquad Equation ( I )$$

where w represents a weight, n is a batch size, and η is a learning rate.

As shown in equation (I), the batch size and the learning rate actually affect convergence of the weight. When the batch size is large, a number of batches can be reduced, thereby reducing a training time. However, on the contrary, a larger amount of learning requires a larger number of iterations, resulting in poor performance of the model and a larger amount of generated data. An excessively small learning rate indicates a very small weight update range, resulting in very slow training. An excessively large learning rate results in a failure to converge. Therefore, in addition to providing a proper training set, the setting step S10 also needs to set a range for parameters. For example, the set parameters include a batch size and a learning rate. The batch size ranges from 0.5 to 1.5, and the learning rate ranges from 0.5 to 1.5. Preferably, the batch size ranges from 0.7 to 1.3, and the learning rate ranges from 0.7 to 1.3. However, the above is merely an example but not a limitation, and relevant parameters are not limited to the batch size and the learning rate.

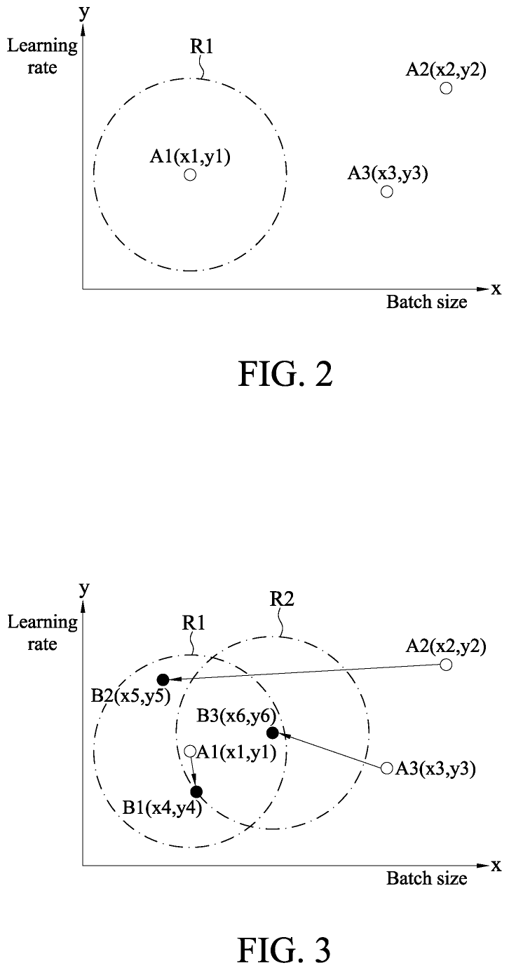

FIG. 2 is a schematic diagram of an initialization step. As shown in FIG. 2, the initialization step S20 includes randomly selecting at least three initial set values A1, A2, and A3 from the numerical range for the training parameters. For example, herein, coordinate values of the randomly selected three initial set values A1, A2, and A3 on a coordinate system having the batch size as a horizontal axis and the learning rate as a vertical axis are (x1, y1), (x2, y2), (x3, y3) below. This is merely for ease of presentation on a plane, and actual parameters are not limited thereto.

Then an accuracy rate of each of the three initial set values is calculated according to the training set. The accuracy rate (ACC) is calculated through 1-loss. The three calculated accuracy rates are compared, and a first parameter range R1 is set by using the initial set value (for example, A1) of the at least three initial set values A1, A2, and A3 that has a highest accuracy rate as a first core value and using a parameter coordinate value (x1, y1) of the first core value as a physical center. The first parameter range R1 herein is a circle on the coordinate system having the batch size and the learning rate as a horizontal axis and a vertical axis respectively, which has the first core value (x1, y1) as a center of circle. A radius of the circle may be 1/2\sqrt{(x1²+y1²)} herein. However, this is merely an example, and a specific radius value may also be pre-selected as the first parameter range R1.

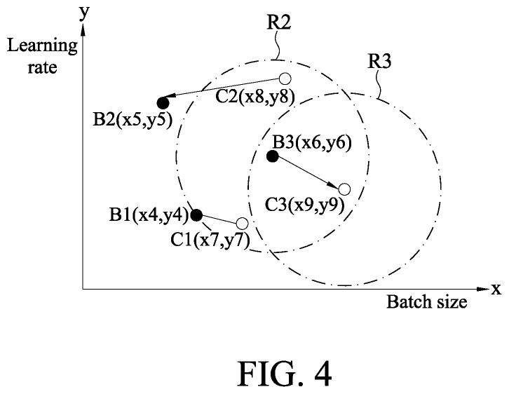

FIG. 3 is a schematic diagram of a parameter optimization step. As shown in FIG. 3, the parameter optimization step S30 includes selecting at least three first iteration values B1, B2, and B3 from the first parameter range R1, calculating an accuracy rate of each of the first iteration values B1, B2, and B3 according to the training set, comparing the accuracy rates of the at least three first iteration values B1, B2, and B3, and setting a second parameter range R2 by using the first iteration value (for example, B3) of the at least three first iteration values that has a highest accuracy rate as a second core value and using a parameter coordinate value (x6,y6) of the second core value as a physical center. A radius of the circle may be 1/2\sqrt{(x6²+y6²)} herein. However, this is merely an example, and a specific radius value may also be pre-selected as the first parameter range R1.

The determination step S40 includes determining whether the accuracy rate of the second core value is higher than 0.9, if the accuracy rate of the second core value is higher than 0.9, ending the parameter optimization step and performing S45 of performing training by selecting the second core value (x6, y6) as a training parameter standard value.

FIG. 4 is a schematic diagram of the parameter optimization step. As shown in FIG. 4, if it is determined in the determination step S40 that the accuracy rate of the second core value is not higher than 0.9, the first core value (x1, y1) and the first parameter range R1 are replaced with the second core value (x6, y6) and the second parameter range R2 respectively, the parameter optimization step S30 is repeated, at least three second iteration values C1, C2, and C3 are selected, an accuracy rate of each of the second iteration values C1, C2, and C3 is calculated according to the training set, the accuracy rates of the at least three second training set values C1, C2, and C3 are compared, and a third parameter range R3 is set by using the second iteration value (for example, C1) of the at least three second iteration values that has a highest accuracy rate as a third core value and using a parameter coordinate value (x7, y7) of the third core value C1 as a physical center. A radius of the circle may be 1/2\sqrt{(x7²+y7²)} herein. The determination step S40 and the parameter optimization step S30 may be repeated in this way until an accuracy rate of a test core value is higher than 0.9, and parameter coordinates of the test core value are set as the training parameter standard value.

Referring to FIG. 1 again, the parameter iteration method S1 for artificial intelligence training further includes a verification step S50. The verification step S50 includes providing a test set. Values in the test set are different from those in the training set. In the verification step S50, the accuracy rate is calculated according to the test set by using the second core value or the test core value in the determination step S40 that is obtained by subsequently repeating the parameter optimization step S30 and that has the accuracy rate higher than 0.9. If the accuracy rate calculated according to the test set is higher than 0.9, the second core value or the test core value is set as the training parameter standard value. If the accuracy rate is lower than 0.9, the parameter is discarded, and the initialization step S20 is performed again.

In the above embodiment, in the initialization step S20, the selection of the batch sizes and the learning rates of the initial set values and the calculation of the accuracy rate are performed by two graphics processors respectively. In other words, selection of the initial set values A1, A2, and A3 in FIG. 2 and calculation of the accuracy rates of the initial set values A1, A2, and A3 are performed by two graphics processors respectively. In this way, computing resources of the graphics processors can be dispersed to achieve faster computing efficiency.

However, FIG. 2 to FIG. 4 are merely examples. Parameters that actually affect training efficiency further include a momentum and a normalization. If three parameters such as a batch size, a learning rate, and a momentum are set, it may be understood that the first parameter range is a sphere on a coordinate system having the batch size, the learning rate, and the momentum as an x-axis, a y-axis, and a z-axis respectively, which has the first core value as a center of sphere. If four parameters such as a batch size, a learning rate, a momentum, and a normalization are set, the first parameter range is a physical quantity range on a coordinate system having the batch size, the learning rate, the momentum, and the normalization as an x-axis, a y-axis, a z-axis, and a w-axis respectively, which has the first core value as a physical center. However, a three-axis space and a four-axis drawn on a plane cannot show an iterative effect, and therefore are not shown herein. Those with ordinary knowledge in the field may conceive transformation between the three-axis and the four-axis space according to FIG. 2 to FIG. 4.

More specifically, if the momentum and the normalization are considered, the momentum ranges from 0 to 1, and preferably, from 0.3 to 0.8, and the normalization ranges from 0.00001 to 0.001, and preferably, from 0.0001 to 0.0005.

Further, in the initialization step S20, in consideration of the momentum and the normalization, any two of the batch size, the learning rate, the momentum, and the normalization may be selected by a first graphics processor, the other two are selected by a second graphics processor, and the accuracy rate is calculated by a third graphics processor. Therefore, by dispersing the computing resources through the three graphics processors, faster computing efficiency and faster gradient descent are achieved.

A comparative example is compared with the embodiment herein. A training set actually used is a standard training set provided by Google. In the comparative example, training is performed by using a standard AI framework, a Tesla 40m (2880CUDA, 12 GB) GPU, and a google tensorflow mode. In the embodiment, four GTX 1050i (768CUDA, 4 GB) GPUs in a serial connection are used. In the above embodiment, the batch size, the learning rate, the momentum, and the normalization range from 0.7 to 1.3, 0.7 to 1.3, 0.3 to 0.8, and 0.001 to 0.005 respectively for training. A result of the comparative example is an accuracy rate of 86% with 14400 seconds spent. However, a result of the embodiment is an accuracy rate of 98% with 900 seconds spent.

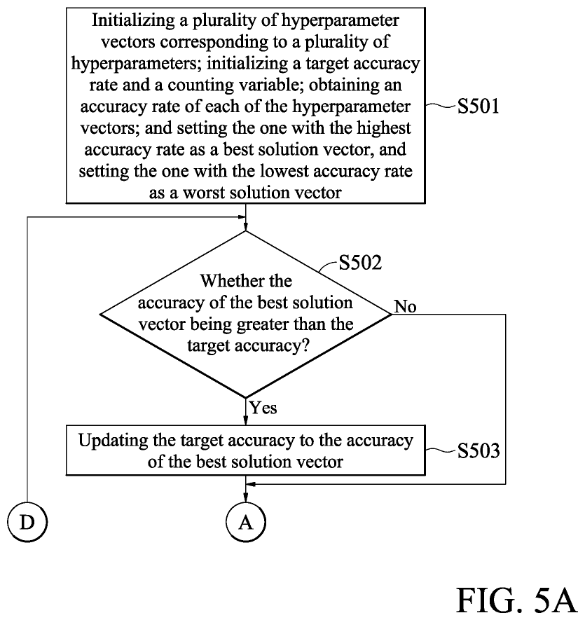

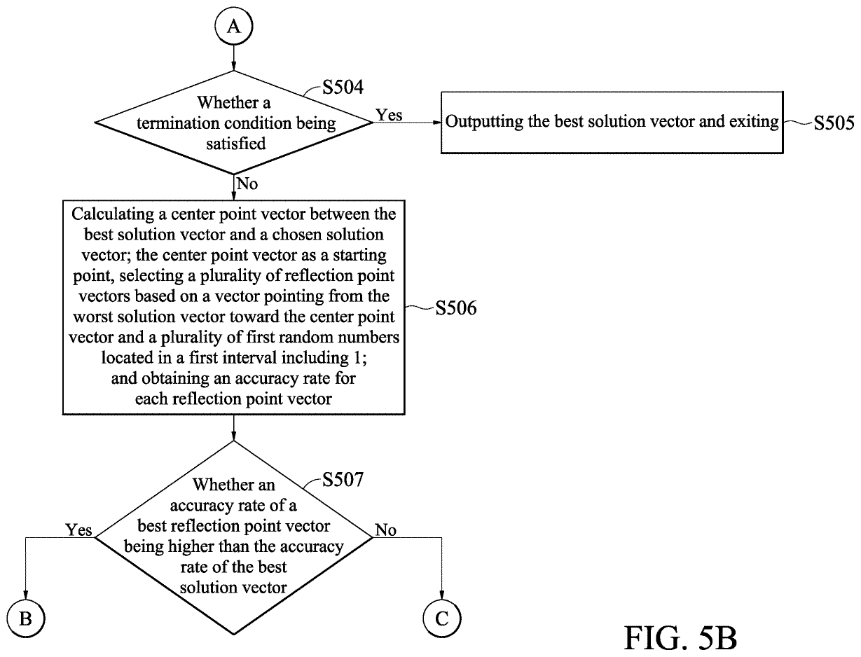

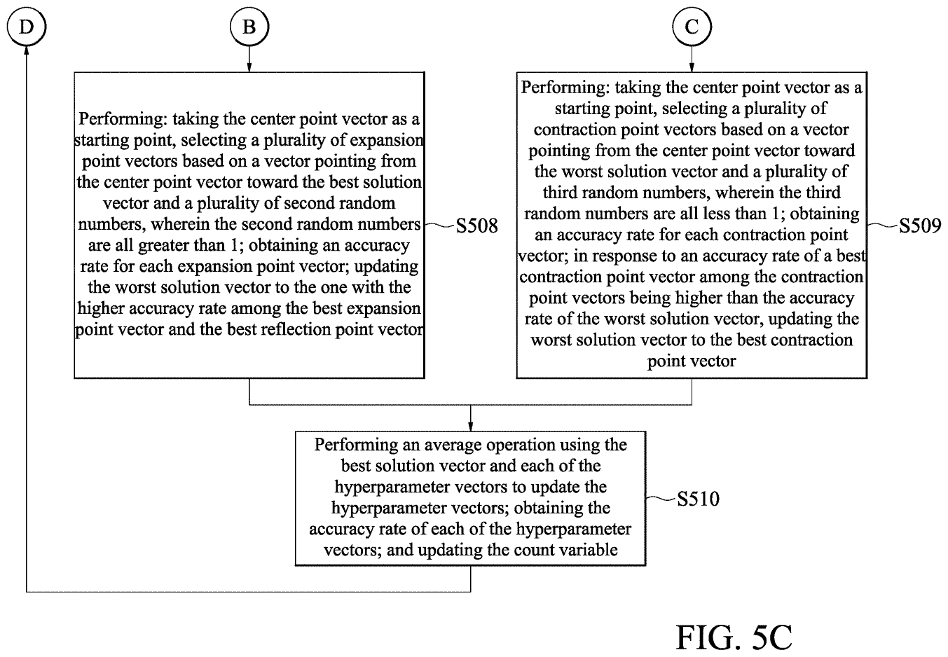

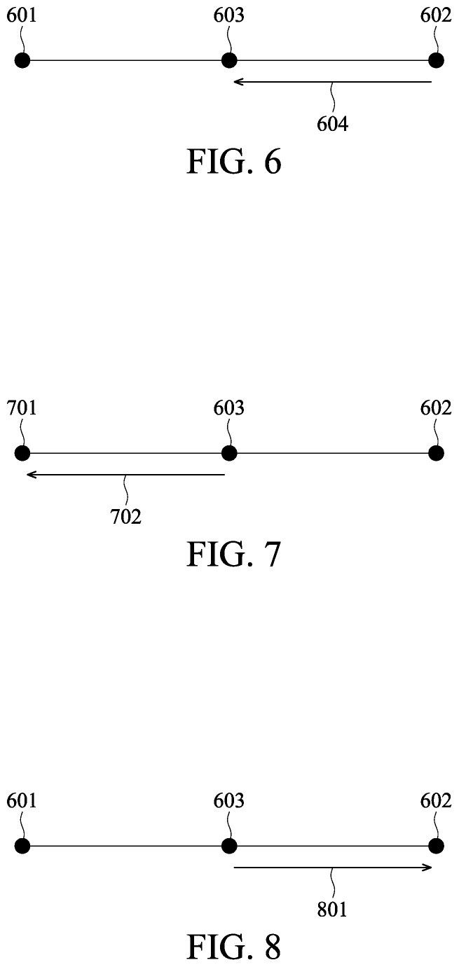

FIG. 5 illustrates a flowchart of a parameter iteration method for artificial intelligence training according to some embodiments of the present invention. FIG. 6 illustrates a schematic diagram illustrating selection of reflection point vectors according to some embodiments of the present invention. FIG. 7 illustrates a schematic diagram illustrating selection of expansion point vectors according to some embodiments of the present invention. FIG. 8 illustrates a schematic diagram illustrating selection of contraction point vectors according to some embodiments of the present invention. Please refer to FIGS. 5 to 8 simultaneously. In this embodiment, the parameter iteration method for artificial intelligence training comprises steps S501 to S510 executed by a processing module. In step S501, the processing module initializes a plurality of hyperparameter vectors corresponding to a plurality of hyperparameters. In this embodiment, values at the same position in the hyperparameter vectors correspond to the same hyperparameter. For example, the hyperparameters comprise a batch size and a learning rate, a value at a first position of the hyperparameter vector can be set to correspond to the batch size, and a value at a second position of the hyperparameter vector can be set to correspond to the learning rate. It is worth noting that the values of the hyperparameter vector can be normalized values so that orders of magnitude of the values at various positions of the hyperparameter vector do not differ too much to cause numerical errors during the iteration process. For example, the batch size can be an original batch size divided by a preset large positive integer so that a numerical range of the batch learning quantity falls near 1. The normalized batch size may be a decimal.

In this step, the processing module initializes a target accuracy rate and a counting variable. The processing module obtains an accuracy rate of each of the hyperparameter vectors and sets the one with a highest accuracy rate as a best solution vector, and sets the one with a lowest accuracy rate as a worst solution vector. In some embodiments of the present invention, the processing module initializes the target accuracy rate to a value greater than 1.

In step S502, the processing module determines whether the accuracy rate of the best solution vector is greater than the target accuracy rate. If yes, step S502 is executed; if no, step S504 is executed. In step S503, in response to the accuracy rate of the best solution vector being greater than the target accuracy rate, the processing module updates the target accuracy rate to the accuracy rate of the best solution vector. In step S504, the processing module determines whether a termination condition is satisfied. If yes, step S505 is executed; if no, step S506 is executed. In step S505, in response to the termination condition being satisfied, the processing module outputs the best solution vector and exits.

In step S506, the processing module calculates a center point vector between the best solution vector and a chosen solution vector, wherein the chosen solution vector refers to a vector that has been preselected from the plurality of hyperparameter vectors. For example, the chosen solution vector can be set to the worst solution vector. Please refer to FIG. 6. In FIG. 6, the chosen solution vector is set as the worst solution vector. If θᵢ represents the value of the best solution vector 601, and θₖ represents the value of the worst solution vector 602, then the value Op of the center point vector 603 is

$$\frac{1}{2} ( {θ}_{i} + {θ}_{k} ) .$$

In this step, the processing module takes the center point vector as a starting point, selects a plurality of reflection point vectors based on a vector pointing from the worst solution vector toward the center point vector and a plurality of first random numbers located in a first interval including 1; and obtains an accuracy rate for each of the reflection point vectors, wherein a quantity of the plurality of first random numbers is a preset quantity. Taking the embodiment illustrated in FIG. 6 as an example, the processing module calculates a vector 604 pointing from the worst solution vector 602 toward the center point vector 603, wherein the value of the vector 604 is θ_{B}−θₖ. In this example, the preset quantity is 3, and the processing module randomly selects the preset quantity of first random numbers α₁, α₂ and α₃ from the first interval including 1. The processing module selects a plurality of reflection point vectors, wherein values θ_{R1}, θ_{R2}, and θ_{R3} of the plurality of reflection point vectors are θ_{R1}=θ_{B}+α₁(θ_{B}−θₖ), θ_{R2}=θ_{B}+α₂(θ_{B}−θₖ), and θ_{R3}=θ_{B}+α₃(θ_{B}−θₖ), respectively. The processing module further obtains the accuracy rate of each of the reflection point vectors based on the values θ_{R1}, θ_{R2}, and θ_{R3} of the reflection point vectors.

In step S507, the processing module determines whether an accuracy rate of a best reflection point vector among the reflection point vectors is higher than the accuracy rate of the best solution vector, wherein the best reflection point vector is the one with a highest accuracy rate among the reflection point vectors. If yes, the processing module executes step S508; if no, the processing module executes step S509.

In step S508, in response to the accuracy rate of the best reflection point vector among the reflection point vectors being higher than the accuracy rate of the best solution vector, the processing module performs: taking the center point vector as a starting point, selecting a plurality of expansion point vectors based on a vector pointing from the center point vector toward the best reflection point vector and a plurality of second random numbers, wherein a quantity of the plurality of second random numbers is the aforementioned preset quantity, and the second random numbers are all greater than 1. The processing module obtains an accuracy rate for each of the expansion point vectors and updates the worst solution vector to the one with the higher accuracy rate between the best expansion point vector and the best reflection point vector. Take the embodiment illustrated in FIG. 7 as an example. In the this step, when the reflection point vectors perform well, the processing module further selects multiple expansion point vectors to expand the search range. In FIG. 7, the chosen solution vector is set as the worst solution vector. The processing module calculates a vector 702 pointing from the center point vector 603 toward the best reflection point vector 701, wherein a value of the best reflection point vector 701 is θ_{Ri}, and a value of the vector 702 is θ_{Ri}−θ_{B}. In this example, the preset quantity is 3, and the processing module randomly selects the preset quantity of second random numbers γ₁, γ₂, and γ₃. The processing module selects a plurality of expansion point vectors, wherein values θ_{E1}, θ_{E2}, and θ_{E3} of the plurality of expansion point vectors are θ_{E1}=θ_{B}+γ₁(θ_{Ri}−θ_{B}), θ_{R2}=θ_{B}+γ₂(θ_{Ri}−θ_{B}), and θ_{R3}=θ_{B}+γ₃(θ_{Ri}−θ_{B}), respectively. The processing module further obtains the accuracy rate of each of the expansion point vectors based on the values θ_{E1}, θ_{E2}, and θ_{E3} of the expansion point vectors.

In step S509, in response to the accuracy rate of the best reflection point vector among the reflection point vectors being not higher than the accuracy rate of the best solution vector, the processing module performs: taking the center point vector as a starting point, selecting a plurality of contraction point vectors based on a vector pointing from the center point vector toward the worst solution vector and a plurality of third random numbers, wherein a quantity of the plurality of third random numbers is the aforementioned preset quantity, and the third random numbers are all less than 1. The processing module obtains an accuracy rate for each of the contraction point vectors. In response to an accuracy rate of a best contraction point vector among the contraction point vectors being higher than the accuracy rate of the worst solution vector, the processing module updates the worst solution vector to the best contraction point vector, wherein the best contraction point vector is the one with a highest accuracy rate among the contraction point vectors. In this step, when the reflection point vectors do not improve the accuracy rate, the processing module narrows the search area to attempt to locate the local optimal solution.

Take the embodiment illustrated in FIG. 8 as an example. In FIG. 8, the chosen solution vector is set as the worst solution vector. The processing module calculates a vector 801 pointing from the center point vector 603 toward the worst solution vector 602, a value of the vector 801 being θₖ−θ_{B}. In this example, the preset quantity is 3, and the processing module randomly selects the preset quantity of third random numbers β₁, β₂, and β₃. The processing module selects a plurality of contraction point vectors, wherein valuesθ_{C1}, θ_{C2}, and θ_{C3} of the plurality of contraction point vectors are θ_{C1}=θ_{B}+β₁(θₖ−θ_{B}), θ_{C2}=θ_{B}+β₂(θₖ−θ_{B}), and θ_{C3}=θ_{B}+β₃(θₖ−θ_{B}), respectively. The processing module further obtains the accuracy rate of each of the contraction point vectors based on the values θ_{C1}, θ_{C2}, and θ_{C3} of the contraction point vectors.

In step S510, the processing module performs an averaging operation using the best solution vector and each of the hyperparameter vectors to update the hyperparameter vectors. The processing module obtains the accuracy rate of each of the hyperparameter vectors. The processing module further updates the counting variable and returns to step S502. For example, if current values of the hyperparameter vectors are θ₁, θ₂, and θ₃, the processing module updates the values of the hyperparameter vectors with

$$\frac{1}{2} ( {θ}_{1} + {θ}_{i} ) , \frac{1}{2} ( {θ}_{2} + {θ}_{i} ) , and \frac{1}{2} ( {θ}_{3} + {θ}_{i} ) .$$

It should be noted that the chosen solution vector may be a vector other than the best solution vector in the hyperparameter vectors. In some embodiments of the present invention, the chosen solution vector is set to a second-best solution vector among the hyperparameter vectors, wherein the second-best solution vector is a vector with a second-highest accuracy rate among the hyperparameter vectors.

In some embodiments of the present invention, the aforementioned counting variable is initially set to 0, and is incremented by 1 at each update to count the number of times steps S502 to S510 are repeatedly executed.

In some embodiments of the present invention, the hyperparameters comprise a batch size and a learning rate. In some embodiments of the present invention, the hyperparameters further comprise a momentum.

In some embodiments of the present invention, the aforementioned termination condition comprises satisfying one selected from the accuracy rate of the best solution vector being greater than a preset accuracy rate and the counting variable being greater than a predetermined integer. That is to say, in step S504, if the processing module determines that the accuracy rate of the best solution vector is greater than the preset accuracy rate or the counting variable is greater than the predetermined integer, the processing module executes step S505.

In some embodiments of the present invention, the first random numbers are all located in an open interval constituted by 0.9 and 1.1, the second random numbers are all located in an open interval constituted by 1.7 and 2.3, and the third random numbers are all located in an open interval constituted by 0.3 and 0.7.

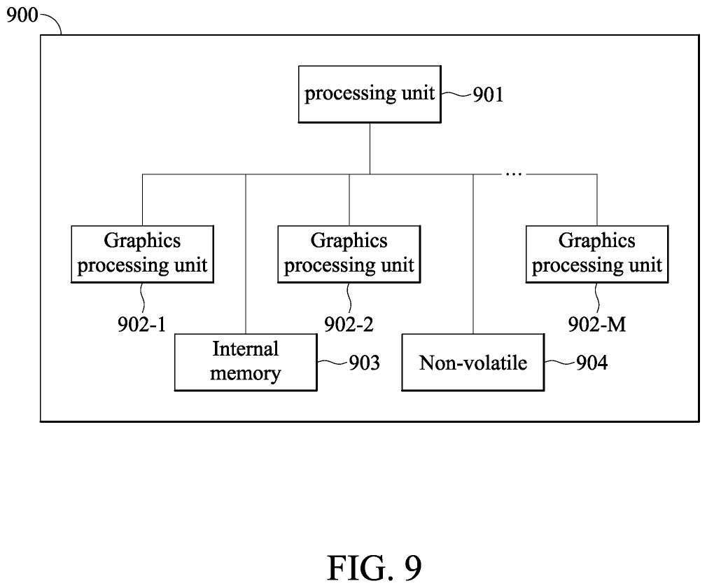

FIG. 9 is a block diagram illustrating an electronic equipment system according to some embodiments of the present invention. In some embodiments of the present invention, an architecture of the aforementioned processing module is as illustrated by a processing module 9011 included in an electronic equipment 900. The processing module 9011 comprises a processing unit 901 and graphics processing units 901-1 to 901-M, wherein M is a positive integer. In some embodiments of the present invention, the quantity M of the graphics processing units 901-1 to 901-M is identical with a quantity of the hyperparameter vectors, and the step of obtaining the accuracy rate of each of the hyperparameter vectors comprises training an artificial intelligence model by the graphics processing units 901-1 to 901-M respectively based on the hyperparameter vectors to obtain the accuracy rate of each of the hyperparameter vectors. The obtaining the accuracy rate for each of the reflection point vectors comprises training the artificial intelligence model by the graphics processing units 901-1 to 901-M respectively based on the reflection point vectors to obtain the accuracy rate for each of the reflection point vectors. The obtaining the accuracy rate for each of the expansion point vectors comprises training the artificial intelligence model by the graphics processing units 901-1 to 901-M respectively based on the expansion point vectors to obtain the accuracy rate for each of the expansion point vectors. The obtaining the accuracy rate for each of the contraction point vectors comprises training the artificial intelligence model by the graphics processing units 901-1 to 901-M respectively based on the contraction point vectors to obtain the accuracy rate for each of the contraction point vectors. In this embodiment, a calculation method of the accuracy rate (ACC) is 1-loss.

In some embodiments of the present invention, the electronic equipment 900 further comprises an internal memory 903 and a non-volatile memory 904. The internal memory 903 is, for example, a Random-Access Memory (RAM). The internal memory 903 and the non-volatile memory 904 are configured to store programs, the programs may include program codes, and the program codes include computer operation instructions. The internal memory 903 and the non-volatile memory 904 provide instructions and data to the processing unit 901.

In conclusion, through the parameter iteration method for artificial intelligence training of this application, the selection of parameters can be quickly optimized, and descent and convergence of the gradient can be quickly achieved, helping improve training efficiency, reduce computing resources, and complete the training with fewer hardware costs. In some embodiments, the search for artificial intelligence training parameters can be accelerated by taking into account the reflection point vector, the expansion point vector, and the contraction point vector.

Although the application has been described in considerable detail with reference to certain preferred embodiments thereof, the disclosure is not for limiting the scope of the application. Persons having ordinary skill in the art may make various modifications and changes without departing from the scope and spirit of the application. Therefore, the scope of the appended claims should not be limited to the description of the preferred embodiments described above.

What is claimed is:

1. A parameter iteration method for artificial intelligence training, executed by a processing module and comprising:
(a) initializing a plurality of hyperparameter vectors corresponding to a plurality of hyperparameters; initializing a target accuracy rate and a counting variable; obtaining an accuracy rate of each of the hyperparameter vectors; and setting the one with a highest accuracy rate as a best solution vector, and setting the one with a lowest accuracy rate as a worst solution vector;
(b) in response to the accuracy rate of the best solution vector being greater than the target accuracy rate, updating the target accuracy rate to the accuracy rate of the best solution vector; in response to a termination condition being satisfied, outputting the best solution vector and exiting; calculating a center point vector between the best solution vector and a chosen solution vector; taking the center point vector as a starting point, selecting a plurality of reflection point vectors based on a vector pointing from the worst solution vector toward the center point vector and a plurality of first random numbers located in a first interval including 1; and obtaining an accuracy rate for each of the reflection point vectors;
(c) in response to an accuracy rate of a best reflection point vector among the reflection point vectors being higher than the accuracy rate of the best solution vector, performing: taking the center point vector as a starting point, selecting a plurality of expansion point vectors based on a vector pointing from the center point vector toward the best solution vector and a plurality of second random numbers, wherein the second random numbers are all greater than 1; obtaining an accuracy rate for each of the expansion point vectors; updating the worst solution vector to the one with a higher accuracy rate between the best expansion point vector and the best reflection point vector;
(d) in response to the accuracy rate of the best reflection point vector among the reflection point vectors being not higher than the accuracy rate of the best solution vector, performing: taking the center point vector as a starting point, selecting a plurality of contraction point vectors based on a vector pointing from the center point vector toward the worst solution vector and a plurality of third random numbers, wherein the third random numbers are all less than 1; obtaining an accuracy rate for each of the contraction point vectors; in response to an accuracy rate of a best contraction point vector among the contraction point vectors being higher than the accuracy rate of the worst solution vector, updating the worst solution vector to the best contraction point vector; and
(e) performing an averaging operation using the best solution vector and each of the hyperparameter vectors to update the hyperparameter vectors; obtaining the accuracy rate of each of the hyperparameter vectors; and updating the counting variable and returning to step (b).

2. The parameter iteration method for artificial intelligence training according to claim 1, wherein the hyperparameters comprise a batch size and a learning rate.

3. The parameter iteration method for artificial intelligence training according to claim 2, wherein the hyperparameters comprise a momentum.

4. The parameter iteration method for artificial intelligence training according to claim 1, wherein the termination condition comprises satisfying one selected from the accuracy rate of the best solution vector being greater than a preset accuracy rate and the counting variable being greater than a predetermined integer.

5. The parameter iteration method for artificial intelligence training according to claim 1, wherein the first random numbers are all located in an open interval constituted by 0.9 and 1.1; wherein the second random numbers are all located in an open interval constituted by 1.7 and 2.3; wherein the third random numbers are all located in an open interval constituted by 0.3 and 0.7.

6. The parameter iteration method for artificial intelligence training according to claim 1, wherein the processing module comprises at least one graphics processing unit, a quantity of the at least one graphics processing unit is identical with a quantity of the hyperparameter vectors, the step of obtaining the accuracy rate of each of the hyperparameter vectors comprises training an artificial intelligence model by the at least one graphics processing unit respectively based on the hyperparameter vectors to obtain the accuracy rate of each of the hyperparameter vectors; the obtaining the accuracy rate for each of the reflection point vectors comprises training the artificial intelligence model by the at least one graphics processing unit respectively based on the reflection point vectors to obtain the accuracy rate for each of the reflection point vectors; the obtaining the accuracy rate for each of the expansion point vectors comprises training the artificial intelligence model by the at least one graphics processing unit respectively based on the expansion point vectors to obtain the accuracy rate for each of the expansion point vectors; the obtaining the accuracy rate for each of the contraction point vectors comprises training the artificial intelligence model by the at least one graphics processing unit respectively based on the contraction point vectors to obtain the accuracy rate for each of the contraction point vectors.

7. The parameter iteration method for artificial intelligence training according to claim 1, wherein the chosen solution vector is the worst solution vector.

8. The parameter iteration method for artificial intelligence training according to claim 1, wherein the chosen solution vector is a second-best solution vector among the plurality of hyperparameter vectors.
